(19) United States
(12) Patent Application Publication
(10) Pub. No.: US 2011/0195597 A1
(43) Pub. Date: Aug. 11, 2011

(54) CONNECTION STRUCTURE OF HOISTWAY CABLE AND DOOR INTERLOCK SWITCH

(75) Inventor: MOON-SU PARK, Seongnam-si (KR)

(73) Assignee: DAELIM ELECTRONICS Co., Ltd, Incheon (KR)

(21) Appl. No.: 13/015,738

(22) Filed: Jan. 28, 2011

(30) Foreign Application Priority Data
Feb. 5, 2010 (KR) 10-2010-0010830

(51) Int. Cl. H01R 4/24

(52) U.S. Cl. 439/395; 439/391

(57) ABSTRACT

Disclosed herein is a connection structure of a hoistway cable and a door interlock switch. The connection structure includes a hoistway cable, a connection wire, a terminal block, and a support block. The hoistway cable includes core wires in a sheath having a shape of a flat band. The core wires include a positive wire having a positive polarity, a negative wire having a negative polarity, and a ground wire for grounding. The connection wire connects any one of the core wires having polarities to both ends of the door interlock switch. The terminal block covers one surface of the hoistway cable, and includes two terminal members each having input and output terminal parts which are integrated with each other, and a cutting member cutting and insulating the core wire. The support block covers the other surface of the hoistway cable and is coupled to the terminal block.

### CROSS-REFERENCE TO RELATED APPLICATION

This application claims priority to and the benefit of Korean Patent Application No. 10-2010-0010830 filed in the Korean Intellectual Property Office on Feb. 5, 2010, the entire contents of which are incorporated herein by reference.

### BACKGROUND OF THE INVENTION

1. Field of the Invention

The present invention relates generally to a connection structure of a hoistway cable and, more particularly, to a connection structure of a hoistway cable and a door interlock switch of a hallway.

2. Description of the Related Art

Generally, an elevator, which is used to transport people and freight in a vertical direction, is constructed so that it is raised or lowered along a hoistway and a door is opened or closed when a user stops at a desired floor. Each floor is provided with an external door which is opened or closed along with an elevator door when the elevator stops at an associated floor. Further, the external door is provided with a safety device so as to prevent an elevator user from falling to the hoistway or from being caught by the door. Such a safety device includes a door lock and a door switch. The door lock prevents an external door of a floor at which the elevator does not stop from opening, unless an emergency key is used. The door switch cuts off a safety circuit unless the door is closed, thus preventing the elevator from moving. The door lock and the door switch are commonly referred to as a door interlock switch.

The door interlock switch is turned off when the door is open, and is turned on when the door is closed, thus transmitting a door closing signal to a controller, therefore causing the controller to drive the elevator. To this end, the door interlock switch of each floor is connected to the controller via a hoistway cable which is installed vertically along the hoistway.

FIGS. 1A and 1B show a conventional connection structure of a hoistway cable 1. In detail, FIG. 1A shows the connection of a controller 22 and door interlock switches 5 using the hoistway cable 1, and FIG. 1B is an electric connection diagram showing the connection of the controller 22 and the door interlock switches 5 using the hoistway cable 1.

As shown in the drawings, the controller 22 is provided in a machine room 20, and an elevator 10 is located in a hoistway 30 in such a way as to be raised or lowered, and the hoistway cable 1 is installed to connect the door interlock switch 5 of an external door 4 of each floor to the controller 22. The hoistway cable 1 functions to connect the controller 22 to each door interlock switch 5, and includes a plurality of core wires. The core wires generally include three strands of wires, namely, a positive wire la having a positive polarity, a negative wire lb having a negative polarity, and a ground wire 1c for grounding.

Here, any one of the core wires having polarities, that is, either the positive wire 1a or the negative wire 1b is connected to the door interlock switch 5 of each floor, the positive wire 1a and the negative wire 1b are connected to each other at the lowermost end of the hoistway 30, and the ground wire 1c is grounded. The electric design may be changed such that the ground wire 1c branches to be connected to the door interlock switch 5.

Because of such an electric connection, when the external door 4 is open, the door interlock switch 5 is turned off so that the elevator 10 stops operating. Only when the external door 4 is closed, the door interlock switch 5 is turned on, thus transmitting an electric signal to the controller 22 and thereby allowing the controller 22 to control the operation of the elevator 10.

The conventional hoistway cable 1 comprises a round cable, and includes a plurality of core wires in a sheath of the cable 1. Conventionally, in order to connect the door interlock switch 5 to any one of the core wires of the hoistway cable 1 having polarities, that is, either the positive wire 1a or the negative wire 1b, as shown in FIGS. 1A and 1B, the hoistway cable 1 is made in the shape of a loop at a connection point and thereafter is fastened by a cable tie. Next, after the sheath of a portion of the loop is peeled off, a connection wire 3 is connected to each terminal of the door interlock switch 5 and is wrapped with insulating tape or the like.

However, such a method has drawbacks in that several operations, including the loop forming operation, the hoistway cable cutting operation, the sheath peeling operation, the door interlock switch connecting operation, the insulating tape wrapping operation, etc., are required, so that it is difficult and complicated to work. Further, over time, the cable tie may become unfastened by the hoistway cable's own load so that the loop may be undesirably undone.

Further, since the core wires provided in the sheath of the hoistway cable have different polarities or different functions, it is necessary to distinguish the core wires from each other. However, in the case of using the round cable, the core wires are mixed with each other in the sheath so that it is difficult to distinguish the core wires from each other. Thus, if the core wires are connected to incorrect positions by mistake, there may be power supply issues and undesirable accidents may occur.

Further, after the sheath peeling operation and the connection-wire connecting operation have been conducted, a connected portion is wrapped with the insulating tape to be finished. Over time, the insulating tape may be detached from the connected portion, so that the core wires may be exposed to the outside, and thus an electric leakage or an electric shock may occur. Further, the conventional connection structure is not reliably waterproofed, so that water sprayed during a grinding operation for a floor of a new building or a floor cleaning operation may permeate into the connection structure, thus causing an electric leakage.

Further, the above-mentioned conventional method may be used only in a site where an elevator is installed. It is impossible to mass produce the connection structure in a harness type in a factory beforehand, so that manufacturing costs and labor costs may be higher.

### SUMMARY OF THE INVENTION

Accordingly, the present invention has been made keeping in mind the above problems occurring in the prior art, and an object of the present invention is to provide a connection structure of a hoistway cable for opening or closing an elevator door, which obviates the necessity of manually peeling off a sheath to connect a hoistway cable to a door interlock switch, makes it easy to distinguish polarities of core wires in the hoistway cable from each other, eliminates the danger of an electric leakage and an electric shock, and can be mass produced beforehand in a harness type using automatic equipment.

In order to accomplish the above object, the present invention provides a connection structure of a hoistway cable and a door interlock switch, including a hoistway cable comprising core wires in a sheath having a shape of a flat band, the core wires being spaced apart from each other by a predetermined interval in such a way as to be parallel to each other and including a positive wire having a positive polarity, a negative wire having a negative polarity, and a ground wire for grounding; a connection wire connecting any one of the core wires having polarities of the hoistway cable to both ends of the door interlock switch; a terminal block covering a first surface of the hoistway cable, and including two terminal members each including an input terminal part and an output terminal part which are integrated with each other, the input terminal part being provided on a first end of each of the terminal members and cutting and penetrating into the sheath of the hoistway cable to be connected to a position of the any one of the core wires having the polarities, the output terminal part being provided on a second end of each of the terminal members and connected to the connection wire, and a cutting member disposed between the two terminal members, and cutting and insulating the core wire connected to the terminal member; and a support block covering a second surface of the hoistway cable, and coupled to the terminal block in such a way as to be compressed against the terminal block, thus supporting the hoistway cable and the terminal block with the core wire being connected to each of the terminal members.

The input terminal part of each of the terminal members may include a blade which is provided on a front end of the input terminal part to cut the sheath of the cable and protrudes from a surface of the terminal block, and a groove which is provided in a central portion of the input terminal part so that a strand of the core wire of the hoistway cable is inserted into the groove.

The cutting member may include a blade which is provided on a front end of the cutting member to cut and penetrate into the sheath of the hoistway cable and protrudes from a surface of the terminal block, and an insulating part which is provided on a rear end of the cutting member and is made of electric insulating synthetic resin, so that the insulating part blocks the core wire which is cut at the front end of the cutting member to be divided into two portions, thus performing an insulating function of preventing electricity from flowing.

Further, the cutting member may include at a central portion thereof a groove such that a strand of the core wire connected to each of the terminal members is inserted into the groove, the groove having a blade to cut the inserted core wire.

Furthermore, the terminal block and the support block may be coupled to each other using a hook, and packing members may be provided between the hoistway cable and the terminal block and between the hoistway cable and the support block.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are views showing a conventional connection structure of a hoistway cable;

FIG. 2 is a perspective view showing a connection structure of a hoistway cable according to the present invention;

FIG. 3 is an exploded perspective view showing the connection structure of the hoistway cable according to the present invention;

FIGS. 4A and 4B are views showing a terminal member and a cutting member of a connector according to the present invention, respectively;

FIG. 5 is a view sequentially showing a terminal-member connecting method in the connection of the hoistway cable, according to the present invention;

FIG. 6 is a view sequentially showing a cutting-member connecting method in the connection of the hoistway cable, according to the present invention; and

FIG. 7 is a schematic view showing the state in which either of polarity core wires (a positive wire or a negative wire) of the hoistway cable is connected to terminal members and is cut to be insulated by the cutting member.

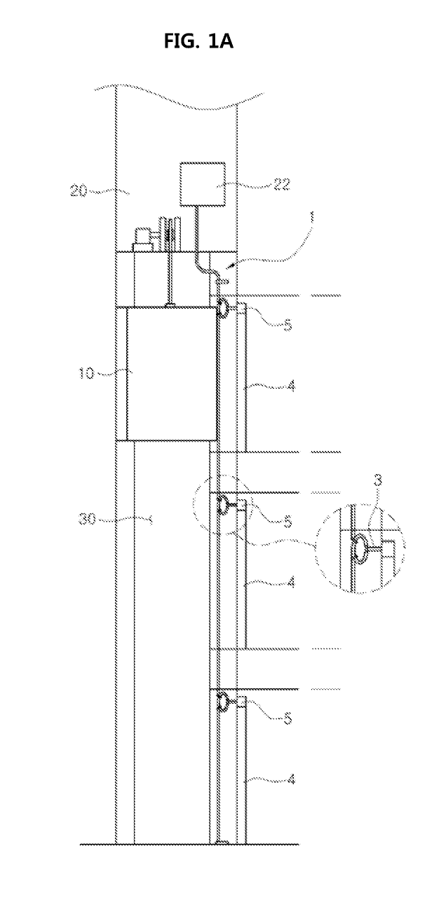

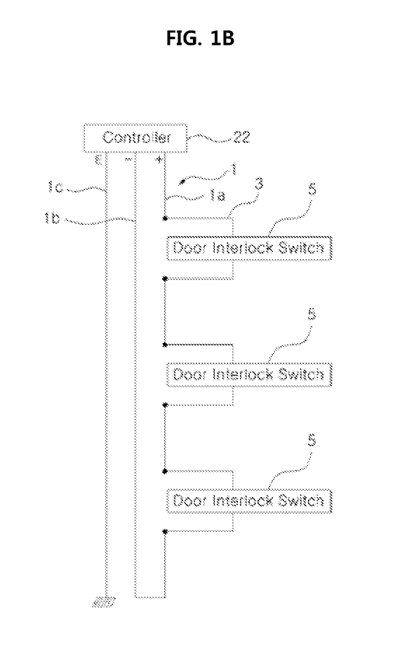

### DESCRIPTION OF THE PREFERRED EMBODIMENTS

Hereinafter, a hoistway-cable connection structure according to a preferred embodiment of the present invention will be described in detail with reference to the accompanying drawings.

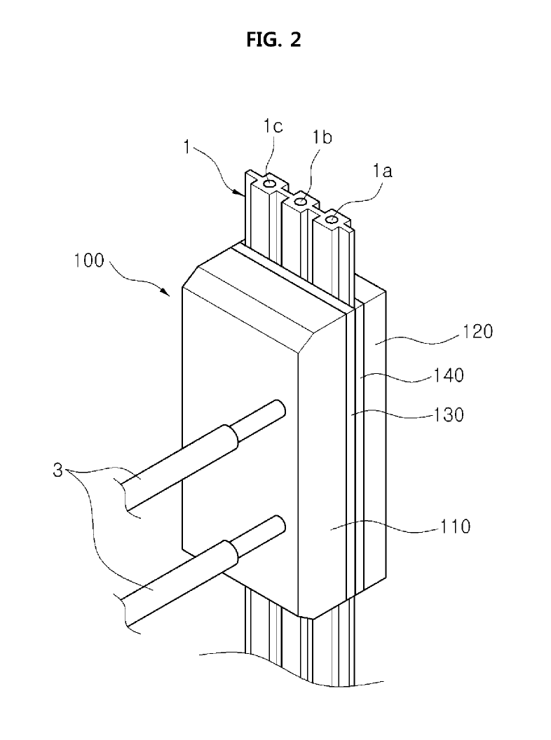

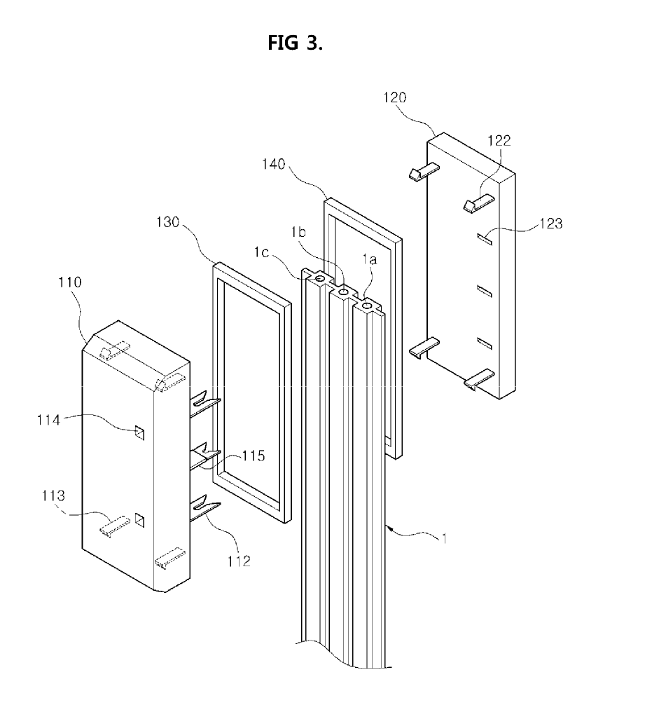

According to the present invention, as shown in FIGS. 2 and 3, in order to connect a hoistway cable to a door interlock switch 5, a hoistway cable 1, a connector 100, and connection wires 3 are required.

In the present invention, the hoistway cable 1 comprises a flat type hoistway cable, in place of a round cable that has been generally used. As shown in FIGS. 2 and 3, the flat type hoistway cable 1 includes a plurality of core wires, namely, a positive wire 1a, a negative wire 1b, and a ground wire 1c in a urethane or PVC sheath having the shape of a flat band. The core wires are spaced apart from each other by a predetermined interval and arranged to be parallel to each other. Preferably, a portion in which each core wire is placed protrudes in a rectangular or circular shape. The hoistway cable 1 extends long in a longitudinal direction, and is vertically fastened to a wall of a hoistway by a fastening means, such as a bracket or a fastening clip.

The hoistway cable 1 constructed as described above is advantageous in that the core wires are placed at predetermined positions in such a way as to be spaced apart from each other by a predetermined interval, so that it is possible to clearly distinguish polarities of the core wires from each other and to precisely connect the core wires, and thus perfect connecting work is achieved.

The connector 100 is a connecting means which is provided to connect the hoistway cable 1 to the door interlock switch 5, and includes a terminal block 110 and a support block 120.

The terminal block 110 covers one surface of the hoistway cable 1, and connects the positive wire 1a or the negative wire 1b of the hoistway cable 1 with the connection wires 3 that will be described below. A body of the terminal block 110 is generally made of a synthetic resin material. Terminal members 112 and a cutting member 115 may be provided in the body by an insert molding method, or the terminal members 112 and the cutting member 115 may be separately manufactured and then inserted into the body. The two terminal members 112 are provided on the inner surface of the terminal block 110 in such a way as to be arranged in a row in a longitudinal direction of the terminal block 110 and to be spaced apart from each other by a predetermined interval. The cutting member 115 is provided between the two terminal members 112 to be spaced apart from each terminal member 112 by a predetermined interval. Here, the cutting member 115 and the terminal members 112 are aligned in a row. Further, hook insert holes 113 are formed in corners of the inner surface of the terminal block 110 so that hooks 122 of the support block 120 which will be described below are fitted into the hook insert holes 113. Terminal holes 114 are formed in the outer surface of the terminal block 110 to connect the respective terminal members 112 to rod terminals 3a of the corresponding connection wires 3 which will be described below.

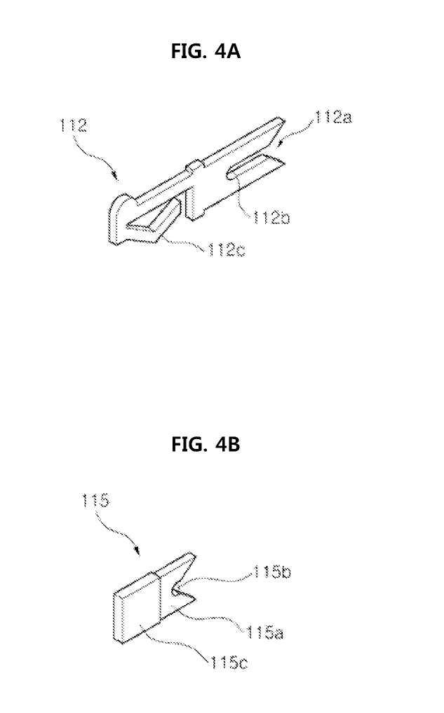

Each terminal member 112 is an electric conductor integrally having an input terminal part 112a and an output terminal part 112c. The input terminal part 112a is provided on one end of the terminal member 112, cuts the sheath of the hoistway cable 1 and penetrates into the cable 1 to be connected to any one of the core wires having polarities, that is, either the positive wire 1a or the negative wire 1b. The output terminal part 112c is provided on the other end of the terminal member 112, and is connected to the rod terminal 3a of each connection wire 3. FIG. 4A shows the detailed construction of the terminal member 112.

As shown in FIG. 4A, the input terminal part 112a has the structure of a two-pronged spear. That is, a blade is provided on a front end of the input terminal part 112a in such a way as to protrude from a surface of the terminal block 110, and cuts the sheath of the hoistway cable 1 to penetrate into the hoistway cable 1. A groove 112b is formed in a central portion of the input terminal part 112a so that any one of the core wires having polarities of the hoistway cable 1, that is, either the positive wire 1a or the negative wire 1b is inserted into the groove 112b. Preferably, the outer portion of the front end of the input terminal part 112a is sharper than the inner portion of the front end. The groove 112b extends long in a longitudinal direction of the terminal member 112.

The output terminal part 112c is the part which is connected to a rear end of the input terminal part 112a and the rod terminal 3a of each connection wire 3. As shown in FIG. 4A, the output terminal part 112c comprises a ‘V’-shaped contact piece which is bent in a ‘V’ shape. The ‘V’-shaped contact piece is bent in the ‘V’ shape when it is fitted into the inner circumference of the terminal hole 114 of the terminal block 110 and the rod terminal 3a of the connection wire 3 is inserted through the terminal hole 114, so that the protruding portion of the contact piece is pressed against the outer circumference of the rod terminal 3a to be elastically deformed and flattened. Thereby, the entire surface of the output terminal part 112c is in surface contact with the outer circumference of the rod terminal 3a, so that electric connection is made.

Meanwhile, the cutting member 115 is the means that is provided between the terminal members 112, and cuts and insulates the positive wire 1a or the negative wire 1b of the hoistway cable 1 connected to the terminal members 112. FIG. 4B shows the construction of the cutting member 115.

As shown in the drawing, the cutting member 115 has on a front end thereof the blade 115a which cuts and penetrates into the sheath of the hoistway cable 1 and protrudes from a surface of the terminal block 110. The cutting member 115 has in a central portion thereof a groove 115b so that either the positive wire 1a or the negative wire 1b of the hoistway cable 1 is inserted into the groove 115b. A blade is also formed in the groove 115b to cut either the positive wire 1a or the negative wire 1b which is inserted into the groove 115b. It is preferable that an outer portion of the front end of the cutting member 115 be sharper than an inner portion of the front end. The groove 115b is preferably curved in a circular shape. Meanwhile, the cutting member 115 has on a rear end thereof an insulating part 115c which is made of electric insulating synthetic resin. The insulating part 115c blocks the positive wire 1a or the negative wire 1b which is cut at the front end of the cutting member 115 to be divided into two portions, thus performing an insulating function so as to prevent electricity from flowing. The cutting member 115 may be separately manufactured and then be coupled to the terminal block 110. Alternatively, the cutting member 115 may be simultaneously manufactured along with the terminal block 110 by an insert molding method.

The support block 120 covers the other surface of the hoistway cable 1 and supports the hoistway cable 1 and the terminal block 110 which are connected to each other. The hooks 122 protrude from left and right ends of the support block 120. The hooks 122 are fitted into the corresponding hook insert holes 113 which are formed in opposite ends of the terminal block 110. Further, insert slits 123 are preferably formed in the inner surface of the support block 120 so that front ends of the terminal members 112 and the cutting member 115 are inserted into the insert slits 123 when the support block 120 is coupled with the terminal block 110.

Each connection wire 3 connects any one of the core wires having polarities of the hoistway cable 1, that is, either the positive wire 1a or the negative wire 1b to the door interlock switch 5, and has on one end thereof the rod terminal 3a. The rod terminal 3a is inserted into the terminal hole 114 of the terminal block 110 to be connected to the corresponding terminal member 112. Consequently, the rod terminal 3a is electrically connected to the positive wire 1a or the negative wire 1b of the hoistway cable 1. The other end of the rod terminal 3a is connected to both ends of the door interlock switch 5.

Meanwhile, packing members 130 and 140 are preferably provided between the hoistway cable 1 and the terminal block 110 and between the hoistway cable 1 and the support block 120. The packing members 130 and 140 have a waterproofing function to prevent water from entering connected portions of the hoistway cable 1 when water flows into the hoistway. As shown in FIG. 3, each packing member 130 or 140 has the shape of a rectangular ring which is hollow therein. When the terminal block 110 and the support block 120 are coupled to each other using the hooks, the packing members 130 and 140 are pressed against opposite surfaces of the hoistway cable 1, thus preventing water from entering the connected portions, thereby preventing an electric leakage and an electric shock. Although not shown in the drawings, in order to achieve more effective waterproofing, it is preferable that a seating groove be further formed in a surface of each packing member 130 or 140 in such a way as to correspond to the protruding portion of the hoistway cable 1.

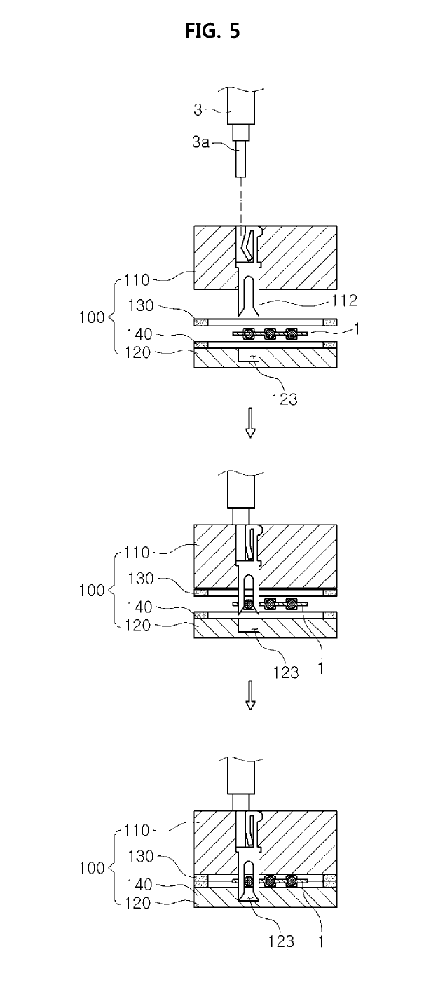

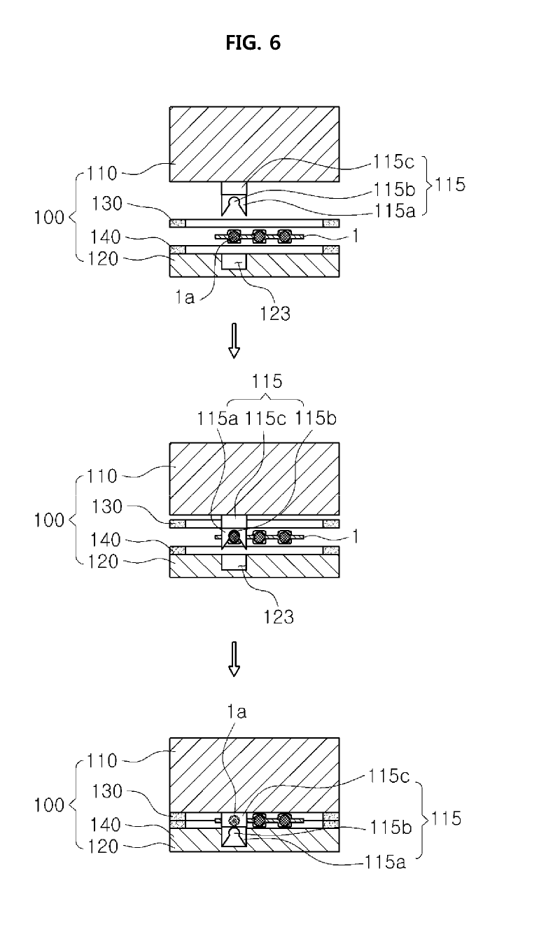

FIG. 5 is a view sequentially showing a terminal-member connecting method in the connection of the hoistway cable 1, according to the present invention, and FIG. 6 is a view sequentially showing a cutting-member connecting method in the connection of the hoistway cable 1.

As shown in FIG. 5, after the hoistway cable 1 is seated on the support block 120, the input terminal part 112a of each terminal member 112 and the cutting member 115 provided on the terminal block 110 are placed to face the support block 120. Next, after each terminal member 112 and the cutting member 115 are aligned with the core wire having a polarity of the hoistway cable 1, that is, either the positive wire 1a or the negative wire 1b, a compressing operation is performed using a jig or the like. At this time, the front end of the input terminal part 112a of the terminal member 112 cuts and penetrates into the sheath of the hoistway cable 1, and the positive wire 1a or the negative wire 1b is inserted into the groove 112b of the input terminal part 112a, so that the hoistway cable 1 is electrically connected to the terminal member 112.

Simultaneously, as shown in FIG. 6, the cutting member 115 provided between the terminal members 112 cuts and penetrates into the sheath of the hoistway cable 1. Thereafter, as the compressing operation is performed with the positive wire 1a or the negative wire 1b being inserted into the groove 115b, the inserted positive or negative wire 1a or 1b is cut by the blade which is formed in the groove 115b. The positive wire 1a or the negative wire 1b which is cut to be divided into two portions as such is blocked by the insulating part 115c of the cutting member 115, thus preventing the flow of electricity.

Further, as shown in FIG. 5, the hooks 122 provided on opposite ends of the support block 120 are fitted into the corresponding hook insert holes 113 of the terminal block 110, so that a firm coupling state is achieved while the terminal members 112 are electrically connected to the hoistway cable 1. Further, if the rod terminal 3a of each connection wire 3 is inserted into the terminal hole 114 of the terminal block 110, the rod terminal 3a is in contact with the output terminal part 112c of the terminal member 112 to be electrically connected thereto. Afterwards, if the other end of the connection wire 3 is connected to both ends of the door interlock switch 5, the entire connecting operation is completed.

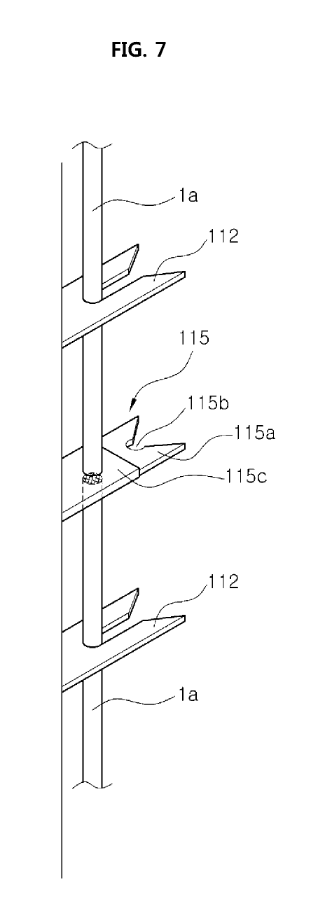

FIG. 7 is a schematic view showing the state in which any one of the polarity core wires (e.g., the positive wire 1a is selected in the drawing) of the hoistway cable 1 is connected to the terminal members 112 and is cut to be insulated by the cutting member 115. As shown in FIG. 7, any one of the polarity core wires of the hoistway cable 1 is connected at different two positions to the terminal members 112. A portion of the core wire provided between the terminal members 112 is cut by the blade 115a which is provided on the front end of the cutting member 115 and then is insulated by the insulating part 115c. Thus, ends of the terminal members 112 may be connected to the door interlock switch 5.

When the hoistway cable 1 is connected to the door interlock switch 5 by the above-mentioned method, this makes it operate easier without manually performing complicated operations, including a cable peeling operation, a wire connecting operation, and an insulating tape wrapping operation, and requires only the operation of connecting the connection wires 3 to the door interlock switch 5 in a site because the hoistway cable 1, the connector 100, and the connection wires 3 may be mass produced in a harness structure beforehand in a factory, thus achieving the effect of saving labor costs due to production automation, and affording easy installation.

Although not shown in the drawings, as described above, an electric design may be changed such that the ground wire is connected to the door interlock switch. In this case, the terminal block may further include a terminal member, a terminal hole, and a connection wire for branching and connecting the ground wire, thus allowing the ground wire to be connected to the door interlock switch.

As described above, the present invention provides a connection structure of a hoistway cable and a door interlock switch which makes it operate easier without manually performing complicated operations, including a cable peeling operation, a wire connecting operation, and an insulating tape wrapping operation, makes it easy to distinguish polarities of core wires from each other, thus preventing obstacles to power supply due to defective connection, and preventing an electric leakage and an electric shock, and requires only a connecting operation of a connection wire in a site because the hoistway cable, a connector, and the connection wire may be mass produced in a harness structure beforehand in a factory, thus achieving the effect of saving labor costs due to production automation, and affording easy installation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A connection structure of a hoistway cable and a door interlock switch, comprising:
a hoistway cable comprising core wires in a sheath having a shape of a flat band, the core wires being spaced apart from each other by a predetermined interval in such a way as to be parallel to each other and comprising a positive wire having a positive polarity, a negative wire having a negative polarity, and a ground wire for grounding;
a connection wire connecting any one of the core wires having polarities of the hoistway cable to both ends of the door interlock switch;
a terminal block covering a first surface of the hoistway cable, and comprising:
two terminal members each comprising an input terminal part and an output terminal part which are integrated with each other, the input terminal part being provided on a first end of each of the terminal members and cutting and penetrating into the sheath of the hoistway cable to be connected to a position of the any one of the core wires having the polarities, the output terminal part being provided on a second end of each of the terminal members and connected to the connection wire; and
a cutting member disposed between the two terminal members, and cutting and insulating the core wire connected to the terminal member; and
a support block covering a second surface of the hoistway cable, and coupled to the terminal block in such a way as to be compressed against the terminal block, thus supporting the hoistway cable and the terminal block with the core wire being connected to each of the terminal members.

2. The connection structure as set forth in claim 1, wherein the input terminal part of each of the terminal members comprises:
a blade provided on a front end of the input terminal part to cut the sheath of the cable, and protruding from a surface of the terminal block; and
a groove provided in a central portion of the input terminal part so that a strand of the core wire of the hoistway cable is inserted into the groove.

3. The connection structure as set forth in claim 1, wherein the cutting member comprises:
a blade provided on a front end of the cutting member to cut and penetrate into the sheath of the hoistway cable, and protruding from a surface of the terminal block; and
an insulating part provided on a rear end of the cutting member, and made of electric insulating synthetic resin, so that the insulating part blocks the core wire which is cut at the front end of the cutting member to be divided into two portions, thus performing an insulating function of preventing electricity from flowing.

4. The connection structure as set forth in claim 3, wherein the cutting member comprises at a central portion thereof a groove such that a strand of the core wire connected to each of the terminal members is inserted into the groove, the groove having a blade to cut the inserted core wire.

5. The connection structure as set forth in claim 1, wherein the terminal block and the support block are coupled to each other using a hook.

6. The connection structure as set forth in claim 1, wherein packing members are provided between the hoistway cable and the terminal block and between the hoistway cable and the support block.
